(19) United States
(12) Patent Application Publication
(10) Pub. No.: US 2015/0274240 A1
(43) Pub. Date: Oct. 1, 2015

(54) VEHICLE-BODY FRAME FOR A MOTORCYCLE, AND MOTORCYCLE INCLUDING SAME

(71) Applicant: HONDA MOTOR CO., LTD., TOKYO (JP)

(72) Inventors: Tomoya MATSUO, WAKO-SHI (JP); Yusuke INOUE, WAKO-SHI (JP)

(21) Appl. No.: 14/665,016

(22) Filed: Mar. 23, 2015

(30) Foreign Application Priority Data
Mar. 27, 2014 (JP) 2014-065300

(51) Int. Cl. B62K 11/04; B62K 25/28; B62K 11/14

(52) U.S. Cl. CPC B62K 11/04; B62K 11/14; B62K 25/283

(57) ABSTRACT

A frame for a motorcycle has good flexibility in a left-right direction. The frame includes left and right main frames extending from a head pipe, pivot frames extending downwardly from respective rear ends of the main frames; and a down frame extending downwardly from the head pipe below the main frames. A reinforcement frame connects the down frame and the main frames together. The frame supports an engine, and the pivot frames swingably support a swing arm thereon. The left and right main frames curve so that a gap formed between the left and right main frames in a vehicle width direction increases from the head pipe toward the rear, while a section height of each of the main frames, in a direction orthogonal to an extending direction of the main frame, decreases from the head pipe toward the rear.

### CROSS-REFERENCE TO RELATED APPLICATIONS

The present invention claims priority under 35 USC 119 based on Japanese patent application No. 2014-065300, filed on Mar. 27, 2014. The entire subject matter of this priority document, including specification claims and drawings, is incorporated by reference herein.

### BACKGROUND OF THE INVENTION

1. Technical Field of the Invention

The present invention relates to The present invention relates to a vehicle-body frame for a motorcycle, and to a motorcycle which incorporates such a frame.

2. Background Art

As shown in, for example, Patent Document 1, a vehicle-body frame for a motorcycle as follows has been conventionally known. (Reference numbers used in this section are taken from the original referenced document.) The vehicle-body frame includes: a head pipe (2) supporting a steering unit supporting a front wheel (24); main frames (3) extending from the head pipe (2) to be inclined downward toward the rear of the vehicle-body frame; pivot frames (4) extending downwardly from rear ends of the main frames (3); a down frame (5) extending downwardly from the head pipe (2) below the main frames (3); and a reinforcement frame (45) connecting the down frame (5) and the main frames (3) to one another. The vehicle-body frame supports an engine (7) and a rear wheel (28) is swingably supported by a swing arm connected to the pivot frames (4).

In the vehicle-body frame of Patent Document 1, the left and right main frames (3) curve in such a way that a gap between the left and right main frames (3) in the vehicle width direction increases from the head pipe (2) toward the rear.

Moreover, as shown in, for example, Patent Document 2, there is also known a vehicle-body frame for a motorcycle in which left and right tank frames (9) connected to a head pipe (2) with a box-shaped frame (7) and connection frames (8) there between and extending rearward are formed such that a section height of each of the tank frames (9) in a direction orthogonal to an extending direction of the tank frame (9) in a side view decreases toward the rear.

[Patent Document 1] Japanese Patent No. 4853900

[Patent Document 2] Japanese Patent Application Publication No. Hei 03-193584.

In the vehicle-body frame described in the above Patent Document 1, the section height of each of the main frames (3) in the direction orthogonal to the extending direction of the main frame (3) in the side view is constant. Accordingly, this frame does not necessarily have excellent flexibility in the left-right direction.

In the vehicle-body frame described in Patent Document 2, the box-shaped frame (7), the connection frames (8), and the tank frames (9) are connected to one another in this order from the head pipe (2) toward the rear, and there are many connecting portions. Accordingly, it is difficult for this frame as a whole to have smooth flexibility. Moreover, since the tank frames (9) are arranged parallel to each other (see FIG. 2 of Patent Document 2), the frame does not necessarily have excellent flexibility in the left-right direction.

### SUMMARY OF THE INVENTION

The An object of the present invention is to provide a vehicle-body frame for a motorcycle, and to a motorcycle that incorporates such a structure, which has smooth and excellent flexibility in a left-right direction as a whole.

For the purpose of solving the above-mentioned problems, the present invention provides a vehicle-body frame for a motorcycle. This vehicle-body frame includes: a head pipe for supporting a steering unit having a front wheel thereon, along with left and right main frames that extend rearwardly from the head pipe and are inclined downward toward the rear of the vehicle-body frame. The vehicle-body frame also includes pivot frames extending downwardly from rear ends of the main frames; a down frame extending downwardly from the head pipe below the main frames; and a reinforcement frame connecting the down frame and the main frames to one another.

The vehicle-body frame is configured for supporting an engine thereon, and the pivot frames swingably support a swing arm thereon, with a rear wheel supported at an end of the swing arm opposite the pivot frames. The left and right main frames curve in such a way that a gap is formed between them in the vehicle width direction, the gap increasing from the head pipe toward the rear. A frame section height of each of the main frames, as viewed in a side view in a direction orthogonal to an extending direction of the main frames, decreases as the main frame extends from the head pipe towards the rear.

In this vehicle-body frame for a motorcycle, because the left and right main frames curve in such a way that the gap formed between the left and right main frames in the vehicle width direction increases from the head pipe toward the rear, and a frame section height of each of the main frames, as viewed in a side view in a direction orthogonal to an extending direction of the main frames, decreases as the main frame extends from the head pipe towards the rear, the frame as a whole can have smooth and good flexibility in a left-right direction.

Moreover, since the left and right main frames curve in such a way that the gap formed between the left and right main frames in the vehicle width direction increases from the head pipe toward the rear, while the frame section height of each of the main frames, as viewed in a side view in a direction orthogonal to an extending direction of the main frames, decreases as the main frame extends from the head pipe towards the rear, external force applied from the front wheel to the head pipe can be effectively received by main frame front portions, which are relatively wide. In addition, it is possible to obtain improved flexibility in the up-down direction from the head pipe toward the rear.

Furthermore, since the frame section height of each of the main frames, as viewed in a side view in a direction orthogonal to an extending direction of the main frames, decreases as the main frame extends from the head pipe towards the rear, a cross section of a connection portion with the pivot frame can be made relatively small. Accordingly, a front wheel load and a rear wheel load can be more easily changed to twisting of the connection portion with the pivot frame, and the flexibility of the frame as a whole is improved.

As described above, in the vehicle-body frame for a motorcycle, since the frame as a whole can have smoother and better flexibility in the up, down, left, right, and twisting directions, the ride quality for a rider can be improved.

The vehicle-body frame may be configured such that a cross-sectional area of each of the left and right main frames in the direction orthogonal to the extending direction continuously decreases from a front end toward a rear end of the main frame.

In such a configuration, the frame as a whole can have smoother and better flexibility in the up, down, left, right, and twisting directions.

The vehicle-body frame for a motorcycle may be configured such that a cross-sectional shape of each of the left and right main frames in the direction orthogonal to the extending direction is an angular cross-sectional shape, and upper and lower outer corner portions both have obtuse angles.

In such a configuration, the frame as a whole tends to have smoother and better flexibility in the up, down, left, right, and twisting directions, particularly smooth flexibility in the twisting direction.

In the vehicle-body frame for a motorcycle, the cross-sectional shape may have a substantially hexagonal outline.

Such a configuration can facilitate flexing of a curved outer surface in each of the main frames.

The vehicle-body frame for a motorcycle may be configured such that the engine is supported by the pivot frames and the reinforcement frame, and is not supported by the main frames.

Such a configuration in which the engine is not supported by the main frames can improve flexibility of the main frames.

In the vehicle-body frame for a motorcycle, the left and right main frames may be formed by swaging.

In such a configuration, the main frames having the shapes described above can be easily formed.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a side view plan showing an example of a motorcycle incorporating a vehicle-body frame according to a selected illustrative embodiment of the present invention.

FIG. 2 is an enlarged detail view, partially cut away, of a central portion of the motorcycle of FIG. 1.

FIG. 3 is an enlarged top plan view, partially cut away, of a front portion of the motorcycle of FIG. 1.

FIG. 4A is a side plan view of a vehicle body frame which is a component part of the motorcycle of FIG. 1.

FIG. 4B is a cross-sectional view, taken along the line b-b in FIG. 4A, showing left and right main frame sections of the vehicle body frame.

FIG. 5 is a partially cut-away top plan view of a front portion of the vehicle body frame; and

FIG. 6 is a perspective view, partially cut-away, of the right main frame section.

### DETAILED DESCRIPTION OF ILLUSTRATIVE EMBODIMENTS

An embodiment of the present invention will now be described, with reference to the drawings. Throughout this description, relative terms like “upper”, “lower”, “above”, “below”, “front”, “back”, and the like are used in reference to a vantage point of an operator of the vehicle, seated on the driver's seat and facing forward. It should be understood that these terms are used for purposes of illustration, and are not intended to limit the invention.

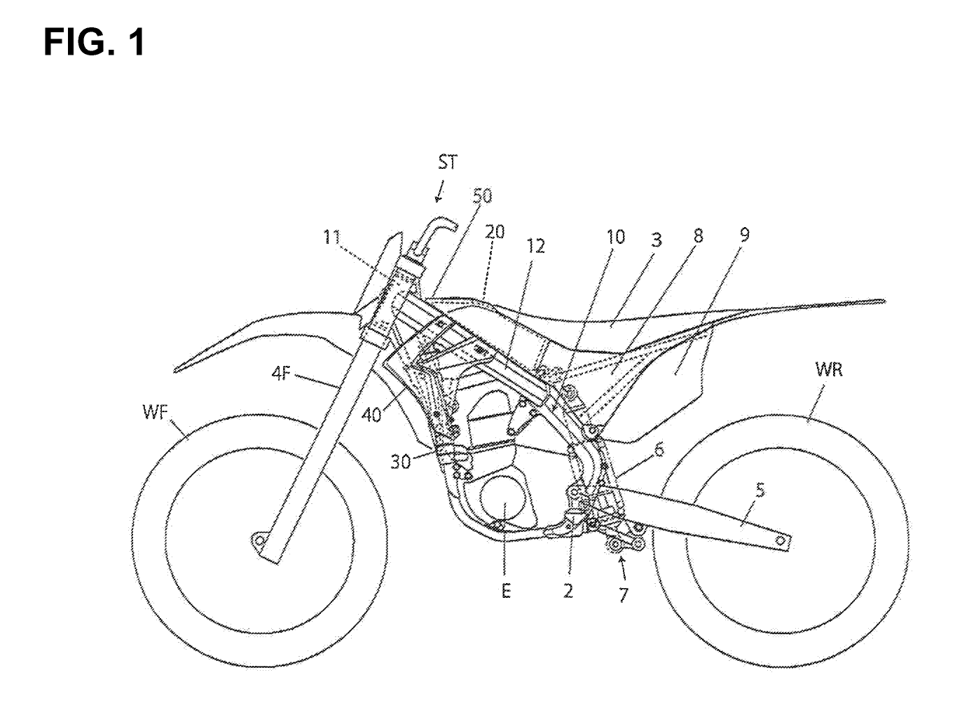

A motorcycle shown in FIGS. 1 to 3 includes a vehicle-body frame 10 according to an illustrative embodiment of the present invention.

The vehicle-body frame 10 illustrated in the drawings includes a head pipe 11 supporting a steering unit ST supporting a front wheel WF, paired left and right main frames 12 (L, R) extending from the head pipe 11 to be inclined downward toward the rear of the vehicle-body frame 10, pivot frames 13 extending downwardly respectively from rear ends 12r of the left and right main frames 12, a down frame 14 extending downwardly from the head pipe 11 below the main frames 12, and a reinforcement frame 15 connecting the down frame 14 and the main frames 12 to one another. The vehicle-body frame 10 supports an engine E, and a rear wheel WR is swingably supported by the pivot frames 13.

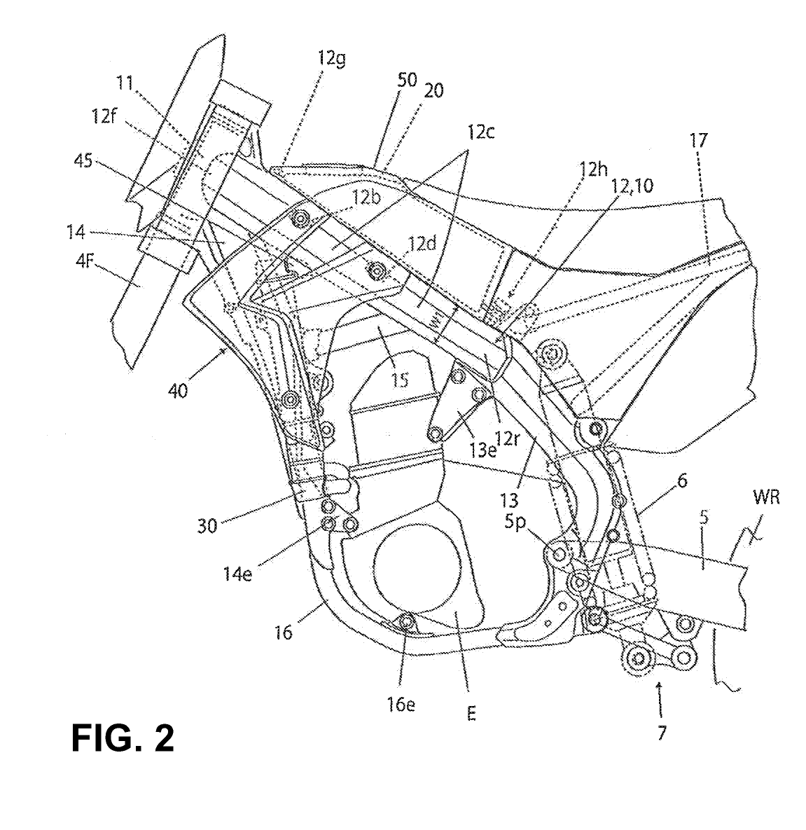

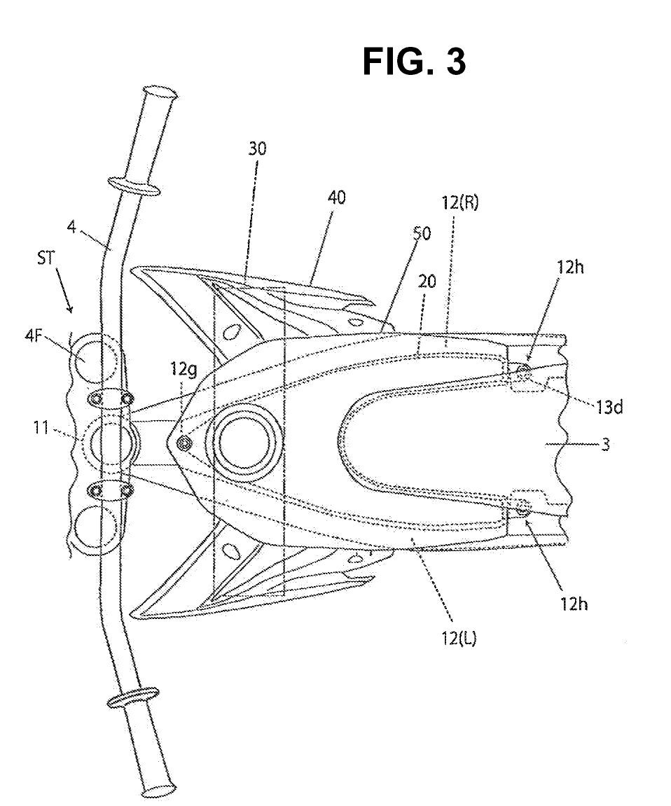

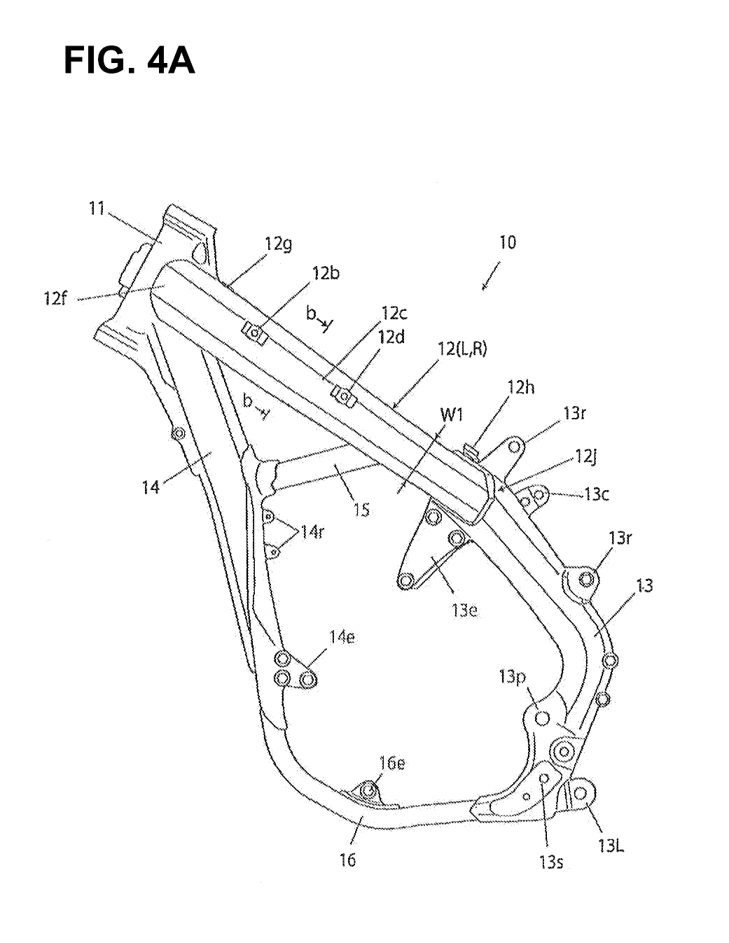

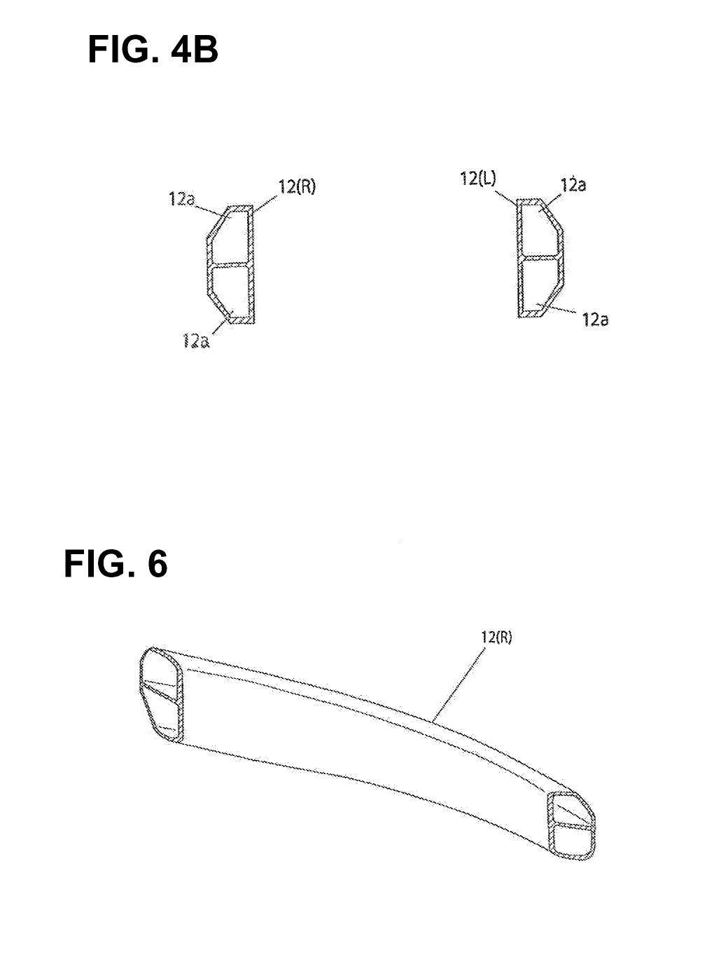

As shown in FIGS. 3 to 5, the left and right main frames 12 are formed to curve in such a way that a gap W2 (FIG. 5) between the left and right main frames 12 in a vehicle width direction increases from the head pipe 11 toward the rear, while a section height W1 of each main frame 12 in a direction orthogonal to an extending direction of the main frame 12 in a side view (FIGS. 2 and 4) decreases from the head pipe 11 toward the rear.

In this vehicle-body frame 10 of a motorcycle, since the left and right main frames 12 curve in such a way that the gap W2 between the left and right main frames 12 in the vehicle width direction increases from the head pipe 11 toward the rear while the section height W1 of each main frame 12 in the direction orthogonal to the extending direction thereof in the side view decreases from the head pipe 11 toward the rear, the frame 10 as a whole can have smooth and excellent flexibility in a left-right direction.

Moreover, since the left and right main frames 12 curve in such a way that the gap W2 between the left and right main frames 12 in the vehicle width direction increases from the head pipe 11 toward the rear while the section height W1 of each main frame 12 in the direction orthogonal to the extending direction thereof in the side view decreases from the head pipe 11 toward the rear, external force applied from the front wheel WF to the head pipe 11 can be efficiently received by main frame front portions 12f, which are relatively wide. In addition, it is possible to obtain flexibility in the up-down direction which becomes smoother and better from the head pipe 11 toward the rear.

Furthermore, since the section height W1 of each of the left and right main frames 12 in the direction orthogonal to the extending direction thereof in the side view decreases from the head pipe 11 toward the rear, a cross section of a connection portion 12j with the pivot frame 13 can be made relatively small. Accordingly, a front wheel load and a rear wheel load can be more easily changed to twisting of the connection portion 12j with the pivot frame 13, and the flexibility of the frame as whole is improved.

As described above, in the vehicle-body frame 10 of a motorcycle, since the frame as a whole can have smooth and excellent flexibility in the up, down, left, right, and twisting directions, ride quality of a rider can be improved.

In FIG. 1, reference numeral 2 denotes a step on which the rider places his/her foot, and reference numeral 3 denotes a seat on which the rider sits. In FIGS. 1 and 3, the steering unit ST includes a steering handle 4 steered by the rider. The steering handle 4 is turnably supported by the head pipe 11, and is used to steer the front wheel WF which, in turn, is supported by a lower end of a front fork 4F.

Reference numeral 5 denotes a swing arm. The swing arm 5 is pivotally supported on the pivot frames 13 by a pivot shaft 5p, and the rear wheel WR is supported at a rear end of the swing arm 5. A cushion unit 6 is provided between the swing arm 5 and the pivot frames 13 to be connected via a link 7. In FIG. 4, reference numeral 13c denotes an attachment portion for an upper end of the cushion unit. In FIG. 1, reference numeral 8 denotes a side cover, 9 denotes a rear side cover, 20 denotes a fuel tank, 30 denotes a radiator, 40 denotes a shroud, and 50 denotes a tank cover.

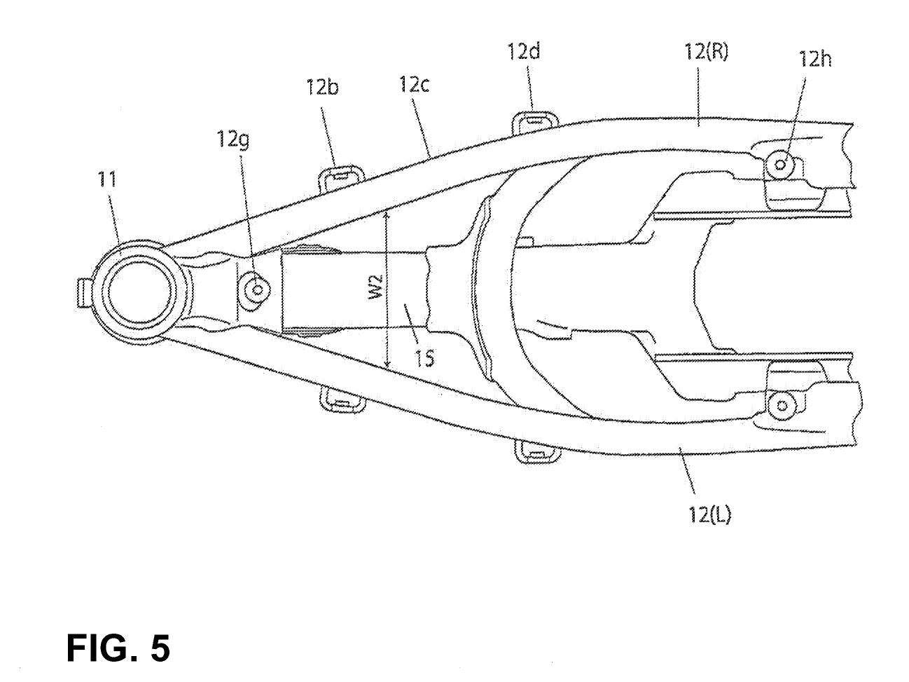

As shown in FIGS. 4 and 6, a cross-sectional area (portions hatched by diagonal lines in FIG. 6) of each of the left and right main frames 12 in the direction orthogonal to the extending direction thereof continuously decreases from the front end 12f toward the rear end 12r. Note that, in FIG. 6, although only the right main frame 12(R) is illustrated, the left main frame 12(L) has the same configuration.

In such a configuration, the frame as a whole can have smoother and better flexibility in the up, down, left, right, and twisting directions.

As shown in FIG. 6 and FIG. 4B, a cross-sectional shape of each of the left and right main frames 12 in the direction orthogonal to the extending direction thereof is an angular cross-sectional shape, and upper and lower outer corner portions 12a both have obtuse angles.

In such a configuration, the frame as a whole tends to have smooth and excellent flexibility in the up, down, left, right, and twisting directions, particularly smooth flexibility in the twisting direction. The aforementioned cross-sectional shape may have a substantially hexagonal outline, as shown. Such a configuration can facilitate flexing of a curved outer surface 12c in each of the main frame 12.

As shown in FIG. 2, the engine E is supported by the pivot frames 13 and the reinforcement frame 15, and is not supported by the main frames 12.

Such a configuration in which the engine E is not supported by the main frames 12 can improve flexing of the main frames 12.

In FIGS. 2 and 4, reference numeral 13e denotes an engine supporting portion in each of the pivot frames 13. The engine E is supported also by an engine supporting portion 14e in the down frame 14 and an engine supporting portion 16e in a lower frame 16 connecting the down frame 14 and the pivot frames 13 to one another.

The left and right main frames 12 are formed by swaging, and having the shapes described above, can be thus easily formed.

In FIGS. 2,4, and 5, reference numerals 12b, 12d denote attachment portions for the shroud 40, 12g, 12h denote attachment portions for the fuel tank 20 and the tank cover 50, 14r (FIG. 4A) denotes attachment portions for the radiator 30, 13r, 13r denote attachment portions for the rear frame 17, 13p denotes an attachment portion for the pivot shaft 5p, 13L denotes an attachment portion for the link 7, and 13s denotes an attachment portion for the step 2 (FIG. 1).

Although the embodiment of the present invention has been described above, the present invention is not limited to the embodiment described above, and various modifications can be made as appropriate within the spirit of the present invention.

For example, although the cross-sectional shape of each of the illustrated main frames 12 is a substantially-rectangular shape with one bar, the cross-sectional shape may be any appropriate shape such as a square shape, a rectangular shape with two parallel bars, a D shape, an oval shape, or a rectangular shape.

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are within the scope of the claims, are intended to be within the scope and spirit of the present invention.

### EXPLANATION OF REFERENCE NUMERALS

E Engine

WF Front Wheel

WR Rear Wheel

ST Steering

10 Vehicle-Body Frame

11 Head Pipe

12 Main Frame

13 Pivot Frame

14 Down Frame

15 Reinforcement Frame

What is claimed is:

1. A vehicle-body frame for a motorcycle, the vehicle-body frame comprising:
a head pipe for supporting a steering unit which supports a front wheel thereon;
left and right main frames extending rearwardly from the head pipe and inclined downwardly toward a rear of the vehicle-body frame;
a pair of pivot frames, with one of said pivot frames extending downwardly from a rear end of each of the main frames, respectively;
a down frame extending downwardly from the head pipe below the main frames; and
a reinforcement frame connecting the down frame and the main frames to one another, wherein:
the vehicle-body frame is configured to support an engine thereon, and the pivot frames are configured to swingably support a swing arm thereon, with a rear wheel supported at an end of the swing arm opposite the pivot frames;
the left and right main frames are formed to curve in such a way that a gap is formed therebetween in a vehicle width direction, said gap increasing from the head pipe toward the rear, and a frame section height of each of the main frames, as viewed in a side view in a direction orthogonal to an extending direction of the main frames, decreases as the main frame extends from the head pipe towards the rear.

2. The vehicle-body frame for a motorcycle according to claim 1, wherein a cross-sectional area of each of the left and right main frames, as viewed in a section taken in the direction orthogonal to the extending direction, decreases from a front end toward a rear end of the main frame.

3. The vehicle-body frame for a motorcycle according to claim 1, wherein a cross-sectional shape of each of the left and right main frames, as viewed in a section taken in the direction orthogonal to the extending direction is an angular cross-sectional shape, and upper and lower outer comer portions both have obtuse angles.

4. The vehicle-body frame for a motorcycle according to claim 2, wherein a cross-sectional shape of each of the left and right main frames, as viewed in a section taken in the direction orthogonal to the extending direction, is an angular cross-sectional shape, and upper and lower outer comer portions both have obtuse angles.

5. The vehicle-body frame for a motorcycle according to claim 2, wherein the cross-sectional shape has a substantially hexagonal outline.

6. The vehicle-body frame for a motorcycle according to claim 3, wherein the cross-sectional shape has a substantially hexagonal outline.

7. The vehicle-body frame for a motorcycle according to claim 4, wherein the cross-sectional shape has a substantially hexagonal outline.

8. The vehicle-body frame for a motorcycle according to claim 1, wherein said frame is configured to support the engine by the pivot frames and the reinforcement frame, and not to support the engine by the main frames.

9. The vehicle-body frame for a motorcycle according to claim 1, wherein the left and right main frames are formed by swaging.

10. The vehicle-body frame for a motorcycle according to claim 2, wherein the left and right main frames are formed by swaging.

11. A motorcycle comprising a vehicle-body frame, wherein the vehicle-body frame comprises:
a head pipe for supporting a steering unit which supports a front wheel thereon;
left and right main frames extending rearwardly from the head pipe and inclined downwardly toward a rear of the vehicle-body frame;
a pair of pivot frames, with one of said pivot frames extending downwardly from a rear end of each of the main frames, respectively;
a down frame extending downwardly from the head pipe below the main frames; and
a reinforcement frame connecting the down frame and the main frames to one another, wherein:
the vehicle-body frame supports an engine thereon, and the pivot frames swingably support a swing arm thereon, with a rear wheel supported at an end of the swing arm opposite the pivot frames;
the left and right main frames are formed to curve in such a way that a gap is formed therebetween in a vehicle width direction, said gap increasing from the head pipe toward the rear, and a frame section height of each of the main frames, as viewed in a side view in a direction orthogonal to an extending direction of the main frames, decreases as the main frame extends from the head pipe towards the rear.

12. The motorcycle according to claim 11, wherein a cross-sectional area of each of the left and right main frames, as viewed in a section taken in the direction orthogonal to the extending direction, decreases from a front end toward a rear end of the main frame.

13. The motorcycle according to claim 11, wherein a cross-sectional shape of each of the left and right main frames, as viewed in a section taken in the direction orthogonal to the extending direction is an angular cross-sectional shape, and upper and lower outer comer portions both have obtuse angles.

14. The motorcycle according to claim 12, wherein a cross-sectional shape of each of the left and right main frames, as viewed in a section taken in the direction orthogonal to the extending direction is an angular cross-sectional shape, and upper and lower outer comer portions both have obtuse angles.

15. The motorcycle according to claim 13, wherein the cross-sectional shape has a substantially hexagonal outline.

16. The motorcycle according to claim 14, wherein the cross-sectional shape has a substantially hexagonal outline.

17. The motorcycle according to claim 11, wherein the engine is supported by the pivot frames and the reinforcement frame, and is not supported by the main frames.

18. The motorcycle according to claim 12, wherein the left and right main frames are formed by swaging.
